(19) United States
(12) Patent Application Publication
(10) Pub. No.: US 2018/0341617 A1
(43) Pub. Date: Nov. 29, 2018

(54) CONTROL DEVICE

(71) Applicant: Kabushiki Kaisha Toshiba, Tokyo (JP)

(72) Inventors: Tatsuo Hirota, Fuchu Tokyo (JP); Motohiko Okabe, Fuchu Tokyo (JP)

(21) Appl. No.: 15/755,857

(22) PCT Filed: Sep. 6, 2016
(86) PCT No.: PCT/JP2016/076202

§ 371 Date: Feb. 27, 2018

(30) Foreign Application Priority Data
Sep. 25, 2015 (JP) 2015-188741

(51) Int. Cl. G06F 13/42

(52) U.S. Cl. CPC G06F 13/42

(57) ABSTRACT

A control device according to one embodiment includes a plurality of modules involved in the control of an external device to be controlled and connected to one another via a field bus. The modules include a controller module and a communication module. The controller module calculates control data related to the control of the modules, controls the modules based on the control data, acquires first information related to a failure of at least one of the device to be controlled and the modules, and transmits the acquired first information to a monitoring device via a first network. The communication module includes a memory capable of storing therein the control data and the first information, and transmits the control data and the first information stored in the memory to external devices including the monitoring device over a second network that is different from the first network, once in every predetermined time period.

### FIELD

Embodiments of the present invention relates to a control device.

### BACKGROUND

PCI-Express has been widely used in computers having a microcomputer, as an interface for connecting function expansion modules. PCI-Express has also come to be widely incorporated into control devices for controlling and monitoring devices to be controlled, such as field devices, motors, valves, sensors, and flowmeters.

In a failure diagnosis for detecting a failure in a plurality of modules mounted on a motherboard of a control device, a controller module that controls the control device detects a failure in the modules via PCI-Express, and notifies an external monitoring device of the detection result of a failure in the modules, via a communication module.

Generally used as a method by which the controller module detects a failure in a module includes a method for reading error information stored in a memory provided to each of the modules on the regular basis (what is called polling), or a method for using an interruption signal issued by each of the modules to isolate a failure in the modules.

### CITATION LIST

### Patent Literature

Patent Literature 1: Japanese Patent Application Laid-open No. 2013-211773

### SUMMARY OF THE INVENTION

### Problem to be Solved by the Invention

In the method in which the controller module notifies the monitoring device of the result of detecting a failure in the modules, however, the controller module cannot notify the monitoring device of the detection result when the controller module itself fails.

### Means for Solving Problem

A control device according to one embodiment includes a plurality of modules involved in the control of an external device to be controlled. The modules include a controller module and a communication module. The controller module calculates control data related to the control of the modules, controls the modules based on the control data, acquires first information related to a failure of at least one of the device to be controlled and the modules, and transmits the acquired first information to a monitoring device via a first network. The communication module includes a memory capable of storing therein the control data and the first information, and transmits the control data and the first information stored in the memory to external devices including the monitoring device over a second network that is different from the first network, once in every predetermined time period.

### BRIEF DESCRIPTION OF DRAWINGS

FIG. 1 is a schematic illustrating an exemplary configuration of a control system according to an embodiment of the present invention.

FIG. 2 is a schematic illustrating an exemplary functional configuration of a control device included in the control system according to the embodiment.

FIG. 3 is a schematic for explaining an exemplary process of sharing control data and failure information in the control system according to the embodiment.

FIG. 4 is a schematic for explaining an exemplary process of sharing control data and failure information in the control system according to the embodiment.

### DETAILED DESCRIPTION

A control system using a control device according to one embodiment of the present invention will now be explained with reference to the appended drawings.

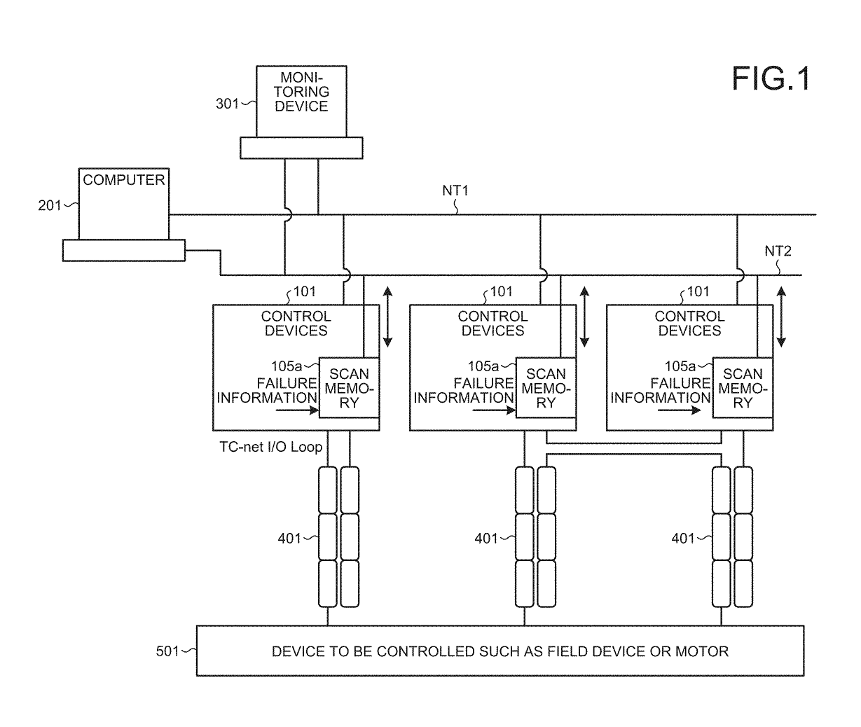

FIG. 1 is a schematic illustrating an exemplary configuration of the control system according to the embodiment. As illustrated in FIG. 1, the control system according to the embodiment includes a plurality of control devices 101, a computer 201, a monitoring device 301, and a device to be controlled 501. The device to be controlled 501 is an external device, such as a field device, a motor, a valve, a sensor, or a flowmeter, that is controlled by the control devices 101, which will be described later.

Each of the control device 101 includes a plurality of modules that are involved in the control of the external device to be controlled 501. The control device 101 controls the device to be controlled 501 via TC-net I/O (registered trademark) 401 by causing the modules to execute controlling operations. The control device 101 is connected to devices such as the other control devices 101, the computer 201, and the monitoring device 301, via an information system network NT1 such as Ethernet (registered trademark) (hereinafter, referred to as an information system network; an example of a first network). The control device 101 then transmits failure information to the external monitoring device 301, over the information system network NT1. The failure information (what is called RAS information; an example of first information) herein is information related to a failure in at least one of the modules themselves included in the control device 101 and the device to be controlled 501.

The control device 101 is also connected to the other control devices 101, the monitoring device 301, and the computer 201 via a control system network NT2 (hereinafter, referred to as a control system network; an example of a second network) based on real-time Ethernet (registered trademark) that is TC-net (registered trademark) standardized in IEC61784-2/61158. The control device 101 is also provided with a scan memory 105a capable of storing therein control data and failure information. The control data herein is information related to the control of the modules provided to the control device 101. The control device 101 then broadcasts the control data and the failure information stored in the scan memory 105a to the other control devices 101 (an example of the external apparatus), the monitoring device 301, and the computer 201 (an example of an external apparatus) on the regular basis (once in every predetermined time period), over the control system network NT2. In this embodiment, the control device 101 broadcasts the control data and the failure information to the monitoring device 301, the other control devices 101, and the computer 201 (hereinafter, referred to as the monitoring device 301 and the like) once in every predetermined time period, but any method may be used to transmit the control data and the failure information to the monitoring device 301 and the like once in every predetermined time period. In this manner, the control device 101 shares the control data and the failure information stored in the scan memory 105a with the other control devices 101, the monitoring device 301, and the computer 201.

The monitoring device 301 is connected to the control devices 101, the computer 201, and the monitoring device 301 via the information system network NT1 and the control system network NT2. The monitoring device 301 detects the status of the control devices 101 and the computer 201, or detects the status of the TC-net I/O 401 or the device to be controlled 501, based on the failure information received from the control device 101 via the information system network NT1 or the control system network NT2. The computer 201 is connected to the control devices 101 and the monitoring device 301 via the information system network NT1 and the control system network NT2. The computer 201 then executes an operation for controlling the control device 101, based on the failure information received from the control device 101 via the control system network NT2. The computer 201 transmits the control data calculated as a result of this operation to the control devices 101 over the control system network NT2 once in every predetermined time period.

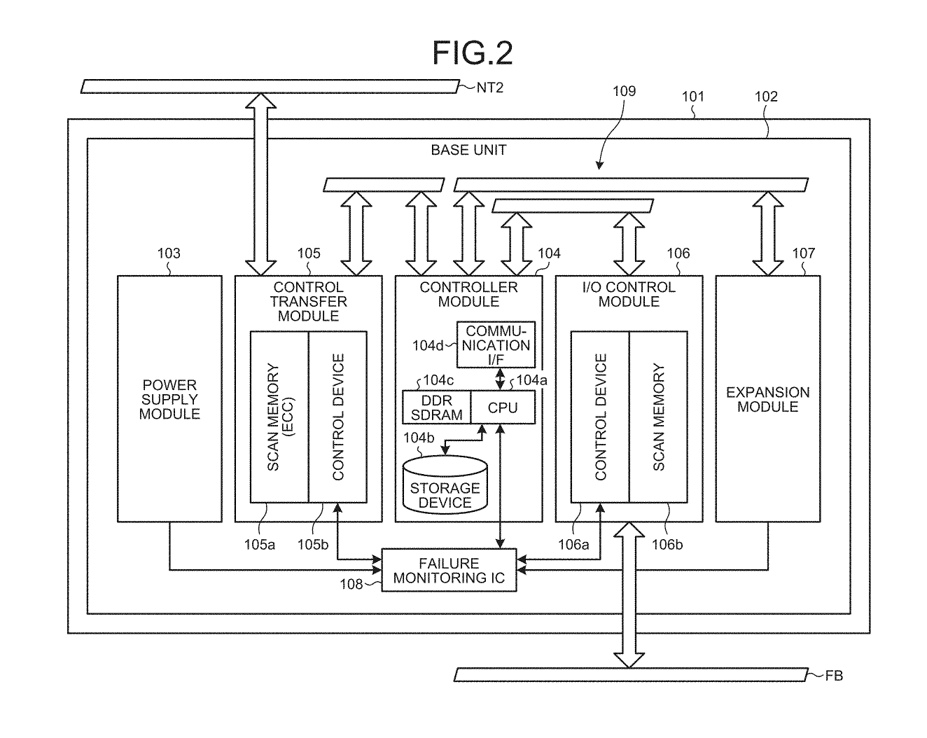

FIG. 2 is a schematic illustrating an exemplary functional configuration of the control device included in the control system according to the embodiment. As illustrated in FIG. 2, in this embodiment, the control device 101 has a base unit 102 for implementing the modules included in the control device 101. The modules implemented by the base unit 102 include a power supply module 103, a controller module 104, a control transfer module 105, an I/O control module 106, an expansion module 107, and a failure monitoring integrated circuit (IC) 108. These modules included in the control device 101 are connected to one another via PCI-Express 109 (an example of a field bus).

The power supply module 103 supplies power to the modules included in the control device 101. The controller module 104 calculates control data. The controller module 104 controls the modules included in the control device 101 based on the control data calculated thereby. In this embodiment, the controller module 104 includes a central processing unit (CPU) 104a, a storage device 104b, a double data rate (DDR) synchronous dynamic random access memory (SDRAM) 104c, and a communication interface (I/F) 104d.

The CPU 104a is a control unit that controls the entire control device 101 by executing a control program stored in a storage device 104b, which is described later. Specifically, the CPU 104a executes a control system operation for controlling the modules included in the control device 101 (e.g., calculates control data), and controls the modules via the PCI-Express 109 based on the operation result. The CPU 104a is also capable of communicating with the other control devices 101, the computer 201, the monitoring device 301, and the like connected over the information system network NT1 by controlling the communication I/F 104d.

In this embodiment, the CPU 104a acquires the failure information from the failure monitoring IC 108, which is described later, and writes the acquired failure information to the storage device 104b. The CPU 104a also transmits the failure information stored in the storage device 104b to the monitoring device 301 over the information system network NT1, by controlling the communication I/F 104d.

The storage device 104b can store therein various types of information such as the control program executed by the CPU 104a, the control data, and the failure information. The DDR SDRAM 104c functions as a working area when the CPU 104a executes various operations. Specifically, the DDR SDRAM 104c stores therein various types of information such as the results of operations executed by the CPU 104a, and the failure information to be transmitted to the monitoring device 301. The DDR SDRAM 104c also has an error check correct (ECC) function of detecting an error in the failure information stored in the DDR SDRAM 104c, and for correcting the detected error. The communication I/F 104d can also communicate with external devices such as the other control devices 101, the computer 201, and the monitoring device 301 that are connected over the information system network NT1.

The control transfer module 105 (an example of a communication module) includes a scan memory 105a and a control device 105b. The scan memory 105a is an example of a memory capable of storing therein information to be shared with the other control devices 101, the monitoring device 301, and the computer 201 (for example, the control data and the failure information). In this embodiment, the scan memory 105a has an ECC function of detecting an error in the control data or the failure information, for example, stored in the scan memory 105a, and for correcting the detected error.

The control device 105b receives the control data from the other control devices 101 or the computer 201 over the control system network NT2. The control device 105b also acquires the control data calculated by the controller module 104, via the PCI-Express 109. The control device 105b also acquires failure information from the failure monitoring IC 108, which is described later. The control device 105b writes the control data acquired from the other control devices 101 or the computer 201, the control data acquired from the controller module 104, and the failure information acquired from the failure monitoring IC 109, to the scan memory 105a. The control device 105b then scan-transfers the control data and the failure information stored in the scan memory 105a to the external devices such as the other control devices 101, the monitoring device 301, and the computer 201, over the control system network NT2. In the scan-transfer, the control device 105b broadcasts the control data and the failure information stored in the scan memory 105a to external devices such as the other control devices 101, the monitoring device 301, and the computer 201. In this manner, the control device 101 shares the control data and the failure information stored in the scan memory 105a with the external devices such as the other control devices 101, the monitoring device 301, and the computer 201. In this embodiment, the control device 105b scan-transfers the control data and the failure information stored in the scan memory 105a to external devices such as the other control devices 101, the monitoring device 301, and the computer 201, once in every predetermined time.

The I/O control module 106 can communicate with the device to be controlled 501 that is connected via a field bus FB such as a TC-net I/O loop. In this embodiment, the I/O control module 106 includes a control device 106a and a scan memory 106b. The scan memory 106b stores therein the failure information shared with the device to be controlled 501. The failure information herein is information related to abnormalities having occurred in the device to be controlled 501.

The control device 106a receives a notification of the failure information from the device to be controlled 501, and writes the received failure information to the scan memory 106b. The control device 106a also broadcasts failure information stored in the scan memory 106b to the device to be controlled 501 connected via the field bus FB, once in every predetermined time. In this manner, the control device 101 shares the failure information stored in the scan memory 106b with the device to be controlled 501.

The expansion module 107 is a module for implementing a function of interfacing with other devices other than the computer 201, the monitoring device 301, or the device to be controlled 501, and a function of expanding a memory. The failure monitoring IC 108 (an example of a detecting unit) acquires the information of a failure in the modules included in the control device 101, including the controller module 104, and writes the acquired failure information to the scan memory 105a via the control device 105b. The failure monitoring IC 108 acquires the failure information from the scan memory 106b included in the I/O control module 106, and writes the acquired failure information to the scan memory 105a via the control device 105b.

In this embodiment, the failure monitoring IC 108 detects a failure in general purpose input/output (GPIO), a low pin count (LPC) interface, or in the modules included in the control device 101. The failure monitoring IC 108 writes the failure information including detection results of failures in the modules, and the failure information acquired from the scan memory 106b included in the I/O control module 106 to the storage device 104b, via the CPU 104a. The failure monitoring IC 108 also writes the failure information including the results of detecting failures in the modules to the scan memory 105a via the control device 105b.

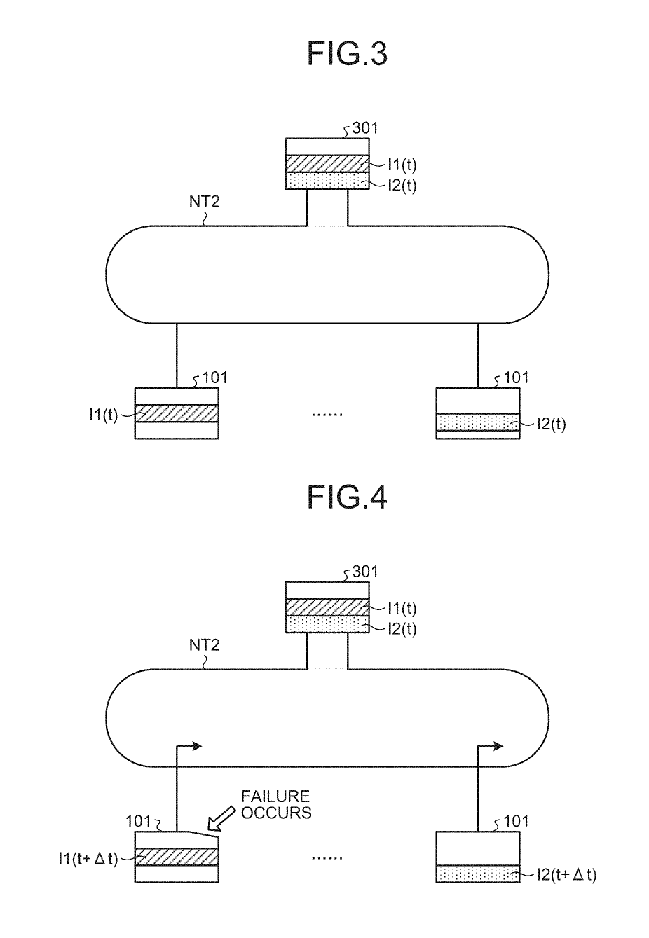

A process of sharing the control data and the failure information in the control system according to the embodiment will now be explained with reference to FIGS. 2 to 4. FIGS. 3 and 4 are schematics for explaining an exemplary process of sharing the control data and the failure information in the control system according to the embodiment. In this embodiment, as illustrated in FIG. 3, the control device 105b included in each of the control devices 101 transmits the control data and failure information I stored in the scan memory 105a to the other control devices 101, the monitoring device 301, and the computer 201 over the control system network NT2, once in every predetermined time, regardless whether a failure has occurred in the device to be controlled 501. In this manner, as illustrated in FIG. 3, even when the device to be controlled 501 (such as a pump installed in a water treatment plant) or any of the modules included in the control device 101 fails at time t, but the controller module 104 is not capable of transmitting failure information I1(t), I2(t) to the monitoring device 301 over the information system network NT1, due to a congestion in the information system network NT1 or a failure of the controller module 104, the control device 105b can transmit the failure information I1(t), I2(t) to the other control devices 101, the monitoring device 301, and the computer 201 over the control system network NT2. Therefore, even when the device to be controlled 501 or the controller module 104 fails, the monitoring device 301 can identify a failure in the device to be controlled 501 or in any of the modules included in the control devices 101 more easily.

Furthermore, even if the information system network NT1 is congested, or the controller module 104 is experiencing a failure when the device to be controlled 501 or any of the modules included in the control device 101 fails at time t+Δt, the control device 105b included in each of the control devices 101 keeps transmitting the control data and the failure information I1(t+Δt), I2(t+Δt) stored in the scan memory 105a to the other control devices 101, the monitoring device 301, and the computer 201 connected over the control system network NT2, once in every predetermined time, as illustrated in FIG. 4. Therefore, it is possible to prevent the failure information I1(t+Δt), I2(t+Δt) stored in the scan memory 105a included in each of the control devices 101 that are connected over the information system network NT2 from being accumulated without being transmitted.

A failure detecting process performed in the control system according to the embodiment will now be explained with reference to FIG. 2. In this embodiment, the failure monitoring IC 108 acquires a POST code of the controller module 104, self-monitoring, analysis and reporting technology (SMART) information of the DDR SDRAM 104c, an error detected with the ECC function of the DDR SDRAM 104c, an abnormality of the power supply module 103, and error information of the expansion module 107, from the modules (e.g., the power supply module 103, the controller module 104, the control transfer module 105, the I/O control module 106, and the expansion module 107), as the failure information, not via the PCI-Express 109. In this manner, even if the interface connecting the controller module 104 and the control transfer module 105 (the PCI-Express 109) fails, the failure information can be written to the scan memory 105a provided to the control transfer module 105. Therefore, the monitoring device 301 can be notified of the failure information via the control system network NT2.

Furthermore, when the failure monitoring IC 108 is to acquire failure information from the controller module 104, but the controller module 104 has failed and is not operable, the failure monitoring IC 108 acquires the failure information from each of the modules, not via the controller module 104. The failure monitoring IC 108 then writes the acquired failure information to the scan memory 105a in the control transfer module 105. In this manner, even when the controller module 104 fails, and no access can be made to the controller module 104 via the PCI-Express 109, the failure monitoring IC 108 can acquire the module failure information. Therefore, the acquired failure information can be transmitted to the monitoring device 301 via the control system network NT2.

Another example of the failure detecting process in the control system according to the embodiment will now be explained with reference to FIG. 2. The failure monitoring IC 108 has a health counter function of accessing the scan memory 105a included in the control transfer module 105 via the PCI-Express 109, by controlling the controller module 104a, and for detecting a failure (what is called a health status) in the PCI-Express 109 and the scan memory 105a based on whether the access succeeds.

In this embodiment, the failure monitoring IC 108 detects the health status by accessing the scan memory 105a via the PCI-Express 109, once in every predetermined time. The failure monitoring IC 108 then acquires a result of the health status detection as the failure information, and writes the acquired failure information to the scan memory 105a. In this manner, because the monitoring device 301 can be notified of the failure information including the health status, the monitoring device 301 can manage a failure having occurred in the control device 101 more specifically.

The ECC function of the scan memory 105a in the control device 101 according to the embodiment will now be explained with reference to FIG. 2. In this embodiment, the scan memory 105a has an ECC function. The scan memory 105a detects an error in the failure information stored in the scan memory 105a.

If the detected error is a correctable error, the scan memory 105a corrects the failure information. If the detected error is an uncorrectable error, the scan memory 105a notifies the controller module 104 that the failure information has an uncorrectable error. In this manner, because the monitoring device 301 can be notified of failure information with an error corrected, the reliability of the scan memory 105a storing therein failure information can be ensured.

In this manner, with the control device 101 according to the embodiment, even if the information system network NT2 is congested or the controller module 104 has failed, the monitoring device 301 can identify a failure in the device to be controlled 501 and a failure in any of the modules included in the control device 101 more easily.

An embodiment of the present invention is as explained above, but this embodiment is provided as a way of example only, and is not intended to limit the scope of the present invention in any way. This novel embodiment can be implemented in various other configurations, and various omissions, replacements, and modifications are possible within the scope not deviating from the spirit of the present invention. This embodiment falls within the scope of the present invention and the essence thereof, and within the scope of the present invention as defined in the appended claims and equivalent thereof.

What is claimed is:

1. A control device comprising a plurality of modules involved in control of an external device to be controlled and connected to one another via a field bus, wherein
the modules include:
a controller module that calculates control data related to control of the modules, that controls the modules based on the control data, that acquires first information related to a failure of at least one of the device to be controlled and the modules, and that transmits the acquired first information to a monitoring device via a first network; and
a communication module that includes a memory capable of storing therein the control data and the first information, and that transmits the control data and the first information stored in the memory to external devices including the monitoring device via a second network that is different from the first network, once in every predetermined time period.

2. The control device according to claim 1, further comprising:
a detecting unit that acquires the first information from each of the modules not via the field bus, and that writes the acquired first information to the memory.

3. The control device according to claim 2, wherein the detecting unit acquires the first information from the modules not via the controller module.

4. The control device according to claim 3, wherein the detecting unit accesses the memory via the field bus by controlling the controller module, detects a failure in the field bus and the memory based on whether the access has succeeded or failed, and acquires a result of detecting a failure in the field bus and the memory as the first information.

5. The control device according to claim 1, wherein the memory has a function of detecting an error in the first information stored in the memory, and correcting the error.
